(19) United States
(12) Patent Application Publication
(10) Pub. No.: US 2011/0038408 A1
(43) Pub. Date: Feb. 17, 2011

(54) METHOD AND SYSTEM FOR PROCESSING OF IMAGES

(75) Inventor: Stephane Jean Louis Jacob, Dubai (AE)

Correspondence Address: GREENBERG TRAURIG, LLP (DC/ORL), 2101 L Street, N.W., Suite 1000, Washington, DC, 20037, US

(73) Assignee: DOO TECHNOLOGIES FZCO, Dubai Airport Free Zone (AE)

(21) Appl. No.: 12/678,059

(22) PCT Filed: Jan. 22, 2008
(86) PCT No.: PCT/IB2008/001155

§ 371 Date: Oct. 5, 2010

(30) Foreign Application Priority Data
Sep. 14, 2007 (GB) GB 0718015.1

(51) Int. Cl. H04N 7/12

(52) U.S. Cl. 375/240.01; 375/E07.026

(57) ABSTRACT

Multiple image streams may be acquired from different sources. The colour depth of the images is first reduced and the streams then combined to form a single stream having a known format and bit depth equal to the sum of the bit depths of the reduced bit streams. Thus, the multiple streams may be processed as a single stream. After processing, the streams are separated again by applying a reverse reordering process.

### FIELD OF THE INVENTION

This invention relates to processing of images and in particular, to processing multiple streams of image data.

BACKGROUND TO THE INVENTION

In many applications multiple images are captured and need to be processed, for example compressed, transported and stored, before viewing.

For example, to monitor a production line, a camera system may include multiple cameras each producing a stream of images. Also, in many 360 video applications, a camera may include, for example, two fish eye lenses and/or a zoom lens each producing streams of images. Fish eye lenses have a wide-angle-field-of-view and many variants exist. A typical fish eye lens can form an image from a 180-degree hemisphere full circle. The two fish eye lenses may, thus, be positioned back to back to capture the entire environment. The zoom lens may zoom in on selected areas of the environment in order to show them in more detail.

Multiple streams of image data may, hence, be produced, and these streams may be of the same or differing formats. For example, the images captured by the zoom lens may be of high definition format. HD resolution video is characterised by its wide format (generally 16:9 aspect ratio) and its high image definition (1920×1080 pixels and 1280×720 pixels are usual frame sizes, as compared with standard video definition (SD) formats where 720×576 pixel size is a usual frame size). In contrast, the images captured by the fish eye lenses, mounted on an appropriate camera, may be very high definition (XHD) resolution images. Very high definition (XHD) format achieves pictures of larger size than high definition (HD) format video. This is desirable in many applications since it increases the user's ability to digitally zoom into the environment.

Each of the images generally has a colour depth which is supported by computers and processing hardware. Colour depth describes the number of bits used to represent the colour of a single pixel in a bitmapped image or video frame buffer, and is sometimes referred to as bits per pixel. Higher colour depth gives a broader range of distinct colours.

Truecolour has 16.7 million distinct colours and mimics many colours found in the real world. The range of colours produced approaches the level at which the human eye can distinguish colours for most photographic images. However, some limitations may be revealed when the images are manipulated, or are black-and-white images (which are restricted to 256 levels with true colour) or “pure” generated images.

Generally, images are captured at 24 or 32 bit colour depth in current standards.

24-bit truecolour uses 8 bits to represent red, 8 bits to represent blue, and 8 bits to represent green. This gives 256 shades for each of these three colours. Therefore, the shades can be combined to give a total of 16,777,216 mixed colours (256×256×256).

32-bit colour comprises 24-bit colour with an additional 8 bits, either as empty padding space or to represent an alpha channel. Many computers process data internally in units of 32 bits. Therefore, using 32 bit colour depth may be desirable since it allows speed optimisations. However, this is at the detriment of increasing the installed video memory.

Streams, either HD or XHD, have a known digital data format. The pixels, represented by a standard number of bits (known colour depth), make up a bit stream of 1's and 0's. Progressive scanning may be used where the image lines are scanned in sequential order, or interlaced scanning may be used where first the odd lines are scanned, then the even ones, for example. Generally, scanning of each line is from left to right. There is usually at least one header made up of 1's and 0's indicating information about the bit streams following it. Various digital data stream formats, including various numbers of headers, are possible and will be known to the skilled person. For the avoidance of doubt, a known data format is any known digital format for any image format (eg HD or XHD).

Streams of image data are often MPEG 2 and 4 compatible.

MPEG-2 is a standard defined by the Moving Picture Experts Group for digital video. It specifies the syntax of an enclosed video bit stream. In addition, it specifies semantics and methods for subsequent encoding and compression of the corresponding video streams. However, the way the actual encoding process is implemented is up to encoder design. Therefore, advantageously, all MPEG-2 compatible equipment is interoperable. At present, the MPEG-2 standard is widespread.

MPEG-2 allows four source formats, or ‘Levels’, to be coded ranging from limited definition, to full HDTV—each with a range of bit rates. In addition, MPEG-2 allows different ‘Profiles’. Each profile offers a collection of compression tools that together make up the coding system. A different profile means that a different set of compression tools is available.

The MPEG-4 standard, incorporating the H.264 compression scheme, deals with higher compression ratios covering both low and high bit rates. It is compatible with MPEG-2 streams and is set to become the predominant standard of the future.

Many compliant recording formats exist. For example, HDV is a commonly used recording format to produce HD video. The format is compatible with MPEG-2, and MPEG-2 compression may be used on the stream.

The output from the MPEG-2 video encoders are called elementary streams (alternatively data or video bit streams). Elementary streams contain only one type of data and are continuous. They do not stop until the source ends. The exact format of the elementary stream will vary dependent on the codec or data carried in the stream.

The continuous elementary bit stream may then be fed into a packetiser, which divides the elementary stream into packets of a certain number of bytes. These packets are known as Packetised Elementary Stream (PES) packets. PES, generally, contains only one type of payload data from a single encoder. Each PES packet begins with a packet header that includes a unique packet ID. The header data also identifies the source of the payload as well as ordering and timing information.

Within the MPEG standard, various other stream formats building on the Packetised Elementary stream are possible. A hierarchy of headers may be introduced for some applications. For example, the bit stream may include an overall sequence header, a group of pictures header, an individual picture header and a slice of a picture header.

In the application of monitoring a production line and many 360 or other video applications, for example, it is desirable to view the image streams taken at the same points in time simultaneously. This enables the user to view the real environment, showing for example the production line or 360 images, and optionally a zoomed in portion for a given point in time. It is also desirable, for many applications, that the image streams be viewed in real time.

We have appreciated that it is desirable to transmit image stream data in a known format, such as streams that are MPEG compatible, so that the commonly used MPEG compatible hardware may be utilised for processing the streams. However, we have also appreciated the need to maintain synchronisation between different streams of image data in transmission and manipulation of the data.

### SUMMARY OF THE INVENTION

The invention is defined in the claims to which reference is now directed.

According to the invention, there is provided a method for processing image data representing pixels arranged in frames, comprising: processing two or more streams of image data to reduce the bit depth of data representing the pixels to produce reduced bit depth streams; combining the reduced bit depth streams into a single stream having a bit depth at least equal to the sum of the bit depths of the reduced bit depth streams; delivering the single stream in a known format; and converting the single stream back into two or more streams of image data.

An advantage of the embodiment of the invention is simultaneous processing, and hence, viewing of multiple streams. If two streams, for example, were transmitted separately over a communication link, one could end up with data from one of the streams arriving before or after the other stream, which would then give problems in concurrently displaying that data on a display. The embodiment of the invention avoids this problem by combining two or more streams of image data and presenting this as a single stream in a format such as HD using MPEG-2 encoding. This single stream can be transmitted and processed using conventional hardware. The synchronisation of the data from the two or more streams is guaranteed because the data is combined together to form a single stream.

Accordingly, an advantage of an embodiment of the present invention is that one may guarantee the data, representing two or more streams of images, remain synchronised during transmission. That is one may guarantee that pixels of frames from one source arrive at a destination at a known time difference or at the same time as pixels from another source. For example, these frames may correspond substantially in relation to the time of capture, thus enabling simultaneous viewing of the image streams. This is advantageous for many applications, including monitoring a production line and various 360 video applications where it is desirable to view the entire environment (captured, for example, by multiple cameras) in real time.

An additional benefit of the invention is that by reducing the colour depth, the bandwidth is reduced prior to transmission of the data. We have appreciated that a reduced colour depth may be sufficient for many applications, so it is acceptable to reduce the bandwidth in this way. For example, only 8 bits colour depth (a maximum of 256 colours) is required for images taken from night time cameras. Consequently, reducing the bit depth from say 24 bits captured to 8 bits does not cause a problematic loss of quality.

Thus, the streams can be combined into a single stream of known format. The length of the resultant stream need not be longer than the longest input stream. This is advantageous leading to the possibility of processing the stream using known techniques and hardware, and particularly doing so in real time. Processing only one stream also simplifies hardware arrangements for delivery of the streams, in comparison to delivering multiple streams over separate communication links.

Whilst embodiments of the invention are advantageous in the processing of multiple video streams where synchronisation is desired, the invention may also be used in a wide range of other applications where it is desirable to process multiple images as a single stream.

Preferably, the images from the separate streams merged together correspond to each other, such as being captured at the same time from different sources.

By using an encryption key to control the merging and converting back of the images the video may be made more secure. Alternatively a look up table may be used to convert the merged images back into their original separated form.

### BRIEF DESCRIPTION OF THE DRAWINGS

An embodiment of the invention will now be described, by way of example only, and with reference to the accompanying drawings, in which:

FIG. 1 is a schematic overview of the functional components of an embodiment of the invention;

FIG. 2 is a schematic diagram of the encoder device of the embodiment;

FIG. 3 is a schematic diagram of an optional second stage of encoding of an embodiment of the invention;

FIG. 4 is a schematic diagram illustrating the decoding device of the embodiment; and

FIG. 5 is a schematic diagram illustrating the encoder process for reducing and combining the reduced bit streams to produce a single stream of known format.

### DESCRIPTION OF A PREFERRED EMBODIMENT OF THE INVENTION

The embodiment of the invention allows multiple image streams to be merged and processed as a single image stream and then converted back to the separate image streams. In the following example, these images are captured by separate image sources which are video sources, but this is only one example.

The embodiment to be described has three separate image sources, with an optional fourth image source. All the video sources may be in real time or a file sequence. In this example, the image sources are part of a camera system monitoring a production line. Two camera imagers are equipped with ultra-wide-angle lenses, such as fish eye lenses, which are positioned back to back to capture the entire surrounding environment (360 degrees). In this example, these camera imagers capture very high definition (XHD) video, which is desirable to enable the user to digitally zoom into the images effectively. It is noted here, for the avoidance of doubt, that XHD encompasses any definition higher than HD. In this case, each XHD source has the same number of pixels for each image frame, since the two camera imagers are identical, producing the same format and aspect ratio of images.

In addition, there is a third camera equipped with a zoom lens, which can provide additional zoom into the environment. In this example, this third camera imager produces high definition HD video. Therefore, each image frame may have the same or a different number of pixels, as the XHD image frames. The camera system described may also combine a fourth HD camera imager.

It should be appreciated that the embodiment is not limited to a certain number of video sources and the techniques to be described may be used with many other combinations of image sources. In particular, whilst the embodiment is particularly useful for processing images of different image formats, it is not limited to such images. The images to be processed may be of the same format or various differing formats. These image formats may be standard or non-standard.

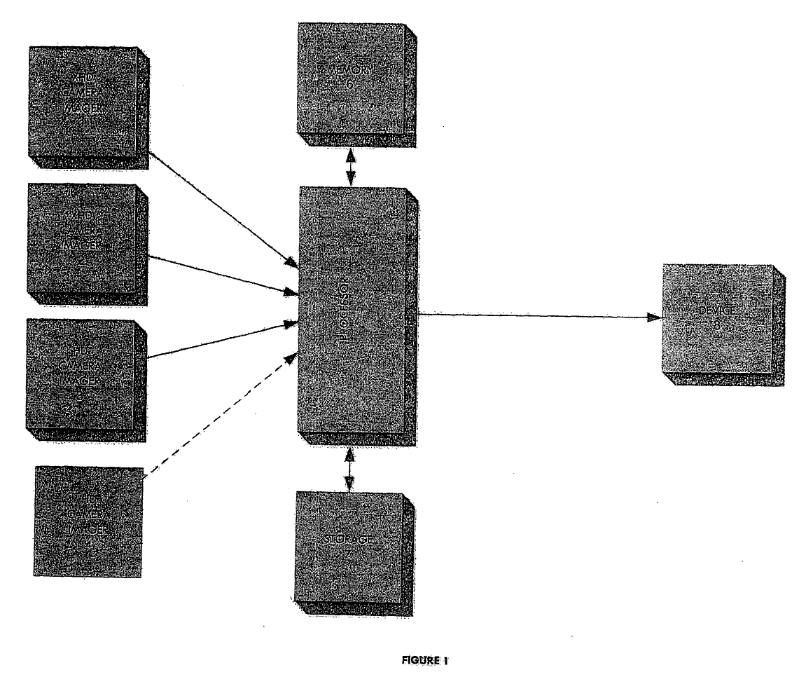

FIG. 1 shows the functional components of a device embodying the invention having three image sources and optional fourth image source 1, 2, 3 and 4. The captured data may be processed by the processor 5, which may be equipped with memory and/or storage capacity 6 and 7 respectively. The image streams are processed by a device 8, which undertakes a process of merging the streams. The functional components of the processor 5, memory 6, storage 7 and device 8 may be embodied in a single device. In such an arrangement, the image sources 1, 2, 3 may be simple image capture devices such as CCD or CMOS sensors with appropriate optics and drive electronics and the processor 5, memory 6 and storage 7 undertake the processing to turn the raw image data into streams. Alternatively, the image sources 1, 2, 3 may themselves be image cameras that produce image streams in XHD or HD format and the processor 5, memory 6 and storage 7 then has less processing formation to perform.

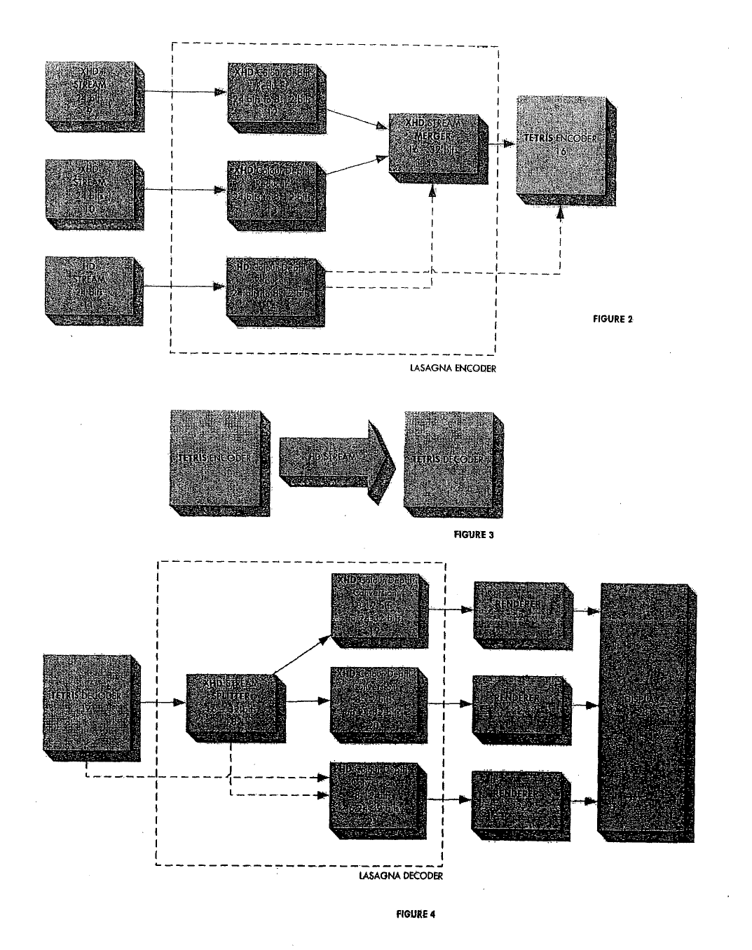

In the encoder, as shown in FIG. 2, there are three video streams, two in XHD and one in HD, from the three image sources having 24 bits colour depth. Colour depth reducers 12, 13 and 14 reduce the colour depth of each image stream from 24 to 8-12 bits. That is each pixel is now represented by 8-12 bits, and the number of colours that may be represented is reduced. For example, 8 bit colour depth gives a maximum number of colours displayed at any one time of 256.

Colour depth reducers to perform this reduction are well known in the art, using for example sampling and quantisation. Many variants exist. For example, a simple technique to reduce the colour depth involves combining bits together, so that the number 0 to 65,536 is represented as the first bit, the number 65,536 to 131,072 is represented by the second bit and so on.

The skilled person would understand that there are many possible techniques for reducing colour bit depth, such as by representing the colour by a colour look-up such that there are fewer colours represented. This reduces the range of colour hues, but should not cause a problem in most applications. The process of colour bit depth reduction operates on the raw pixel data prior to any compression techniques used for transmission.

In this example, each stream is reduced to a uniform colour depth. However, this need not be the case.

A colour depth of 8 bits or greater is suitable/sufficient for many applications, including camera systems monitoring production lines and many 360 camera applications. It should be appreciated that other reductions in colour depth may also suit or be sufficient for various other applications.

A stream merger 15 merges the two XHD and HD video streams, with reduced colour depth, into a single stream which has an overall colour depth of 16-32 bits. In FIG. 2 the processor to perform the merging is called an XHD stream merger, since the image format of the resultant stream in this case is XHD. The merged image stream has a known digital data format and has a colour depth at least equal to the sum of the bit depths of the reduced bit depth streams. In this case, the merged image stream has a maximum bit depth of 32 bits per pixel. Standard 24 or 32 bits colour depth are preferred.

Many combinations for merging the image streams are possible, one example being given in FIG. 5, described later.

In this example, the merged image stream takes the format size of the largest input stream—in this case, XHD. The pixels in the HD image may be rearranged to fit into the XHD image format. Any additional bits needed to unify the colour depth of the resulting stream may be empty padding space.

To result in the combined stream's desired colour depth of 24 or 32 bits the three streams, (2×XHD and 1×HD) each of 8 bits may be merged to create a single stream of 24 bits. Alternatively, the two XHD streams may have 12 bits and the HD stream 8 bits, resulting in a total colour depth of 32 bits. The two XHD streams, each of 12 bits, could also be combined alone to create a resulting stream of 24 bits. This may be desirable, for example, if the XHD stream length is longer than the HD stream length. In the case where there are four input streams (2×XHD and 2×HD), all the streams, if reduced to 8 bits colour depth, could be merged to create a resulting stream of 32 bits colour depth.

It will be appreciated that there are many combinations and possibilities for merging the reduced colour depth streams to produce a known digital data single stream. In particular, there are many combinations and possibilities for producing a desired total colour depth for the merged stream, corresponding to a known format. It will also be appreciated that the known format, and desired colour depth, may vary.

FIG. 5 shows one way of merging the three image sources, 24, 25 and 26 considering the actual digital data information. Initially, at 27, 28 and 29 each of the streams has a header and data frames (ie pixels) with 24 bits. At 30, 31 and 32 the number of bits per data frame (pixel) is reduced to 8 bits, as previously described. At 33, the 8 bit data frames from each of the sources are concatenated to produce a 24 bit data field in the standard format corresponding to one 24 bit “pixel”. This produces data in a digital structure that can be processed in a standard known format but, of course, the 24 bit “pixels” would not represent an actual image. If a processor attempted to display the combined single stream, it would display images with random arrangements of pixels. In order to display the three separate image streams, the single stream must be deconstructed or decoded, as will be discussed later.

It will be appreciated that the reduced bit depth streams may be merged to form a single stream of known format in a variety of other ways. In addition to concatenation, for example, alternate bits may be taken from each source's data frames to produce the merged 24 bit data frames. Such methods may be desirable to increase security.

In this example, the two XHD streams with the same number of pixels for each image frame may be combined by taking the first pixel of a first frame from one source and the first pixel of a first frame from the second source and merging them together (by concatenation or otherwise), as described above. Similarly, the second pixel from one frame is combined with the second pixel of the other source and so on. Other methods for combining the streams are possible and will occur to the skilled person.

If the HD stream has a lower number of pixels per image frame than the XHD streams, the technique described above of concatenating or otherwise combining the reduced bit pixels may still be used. When there are no pixels in the HD image frames left to combine with the XHD stream pixels, empty padding space may be used for example.

Preferably, image frames from the three input streams that correspond to each other are merged. Given that the images remain synchronised throughout subsequent transmission as a single stream, one can guarantee that pixels of frames from one source arrive at a destination at the same time as corresponding pixels from another source.

For example, in the case of a camera system monitoring a production line and many 360 camera applications, preferably, multiple image frames captured at the same time would be merged into single image frames making up a single image stream. This enables the user to synchronise the streams, for example, according to the time point the image streams are captured. Advantageously, this enables viewing multiple video sources simultaneously in real time.

One can synchronise image streams in time prior to merging, for example, by using identical cameras and a single clock source for the digital signal processors in the cameras, so that the cameras are truly synchronised. The digital data streams would then have the first pixel, from the first image frame of one source, at exactly the same time as the first pixel from the first frame of another source. This would simplify the process of then merging the streams, since the data bit streams would already be synchronised.

It is more likely, however, that the sources will not be exactly synchronised because the digital clocks within the devices can be entirely different. In this situation, to synchronise the streams prior to merging, one needs to find the header within each data stream and then delay one of the streams until the headers are aligned. All subsequent digital processing of reducing the bit depth and combining the streams together would then be exactly synchronised.

It should be noted, however, in such preferred embodiments, it is not essential that frames from one source are merged with frames taken at exactly the same time from another source. Since the images remain synchronised throughout subsequent transmission as a single stream slight misalignment may be acceptable. For example, it may be acceptable to have frames from one source merged with frames from another source that are actually a few image frames different in terms of the time they were taken. TV cameras typically have an image frame rate of 50 fields per second. It would not matter if the images merged together were a few fields or frames apart. As long as the system and the decoder knows, it can ensure that the images are displayed at the correct time at the receiver end.

As described above, the raw 24 bit data representing each pixel from an image source is reduced in a bit depth, combined with other reduced pixels from other streams and then packaged into a chosen known format. The resultant data can be made compatible with MPEG-2, for example, or other compression algorithms, by applying colour reduction and merging to patterns of pixels such as 16×16 pattern groups. The chosen groupings of pixels will depend upon the chosen compression scheme.

The bit depth reduction and merging schemes can be fixed or adaptive. If the schemes are fixed, then the encoder and decoder both need to know in advance the arrangements of the schemes. Alternatively, if the schemes are variable or adaptive, then the chosen scheme must be recorded and transmitted from the encoder to the decoder. The encoding scheme can be stored and transmitted as meta data, which may be referred to as a “palette combination map”. This contains the information which explains how the pixels have been reduced in bit depth and combined. For example, in the scheme shown in FIG. 5, the palette combination map comprises a lookup table which explains that each pixel is reduced from 24 bits to 8 bits and then each of 3 pixels is concatenated with a corresponding pixel from a frame of another image in the order first pixel, second pixel, third pixel. This lookup-table or “key” can be used by the decoder to re-assemble the image streams.

The scheme used can be set once and then fixed or be adaptive as described above. If it is adaptive, the scheme could change infrequently, such as once per day, a few times a day, or could be more frequent such as changing with the changing nature of the images being transmitted. If the scheme adapts frequently, then the palette combination map will be transmitted frequently either multiplexed with the image stream data or sent by a separate channel. As this meta data is small, there should be no transmission problem, and so no risk of delay. However, to avoid the possibility that the decoder is unable to operate if the meta data fails to reach the decoder, a default fixed scheme can be used in the absence of the meta data transmisison from encoder to decoder.

Preferably, at XHD stream merger 15 the colour depth information of the individual streams is stored. This information may be stored in a palette combination map generated by the XHD stream merger, where the colour depth information may be embedded in a matrix. This data may be encrypted to increase security.

Preferably, additional information about the individual streams is also stored, so that the merged stream may be decoded. Such information may include the number of initial images/streams, the original location of the image pixels in the separate streams. This data may be embedded in a matrix in the palette combination map, and may also be encrypted, so as to increase security.

The initial image streams may now be processed as a single stream of known format. This may be done using conventional hardware, for example if the format size of the merged images is a standard. For example, as currently is the case, if the format size is HD. This format is MPEG-2 and 4 compatible. Therefore, conventional hardware could be used, for example, if the input streams to be merged were HD format.

In this example, however, the format size of the resulting images is XHD. At present, the compression, transportation and storage of XHD resolution video may be performed using MPEG compression which creates huge file sizes and bandwidth creating transportation and storage problems. Therefore, powerful dedicated processors and very-high-speed networks are required to enable the data to be compressed in real time for applications. These processors and networks are, at present, not widely available nor financially viable.

A method and system for processing images acquired at a first format according to a second format may be used to convert the combined stream to a lower definition format. For example, a method in which pixels are grouped into “patterns” of 16×16 pixels and then transmitted in a HD format could be used. This is shown in FIG. 3 as a “Tetris” encoder and decoder. This is an encoding scheme for converting XHD data to HD data, but is not essential to the embodiment of the invention. Other conversion schemes could be used or, indeed, the data could be kept in XHD format. In future, hardware will allow XHD to be transmitted and processed and the optional conversion step shown in FIG. 3 will not be needed. Thus, conventional HD Codec's can be used to compress and decompress the merged data if desired. In the compressed form the data can be transported and/or stored.

FIG. 2 shows an encoder 16 for converting the XHD merged stream produced by the stream merger 15, into a HD stream. The active picture portion of the images are divided into patterns each having a plurality of pixels. The patterns are assigned coordinate values and then reformatted into HD format using an encryption key which reorders the patterns. This encryption key may be generated by the palette combination map, but this need not be the case.

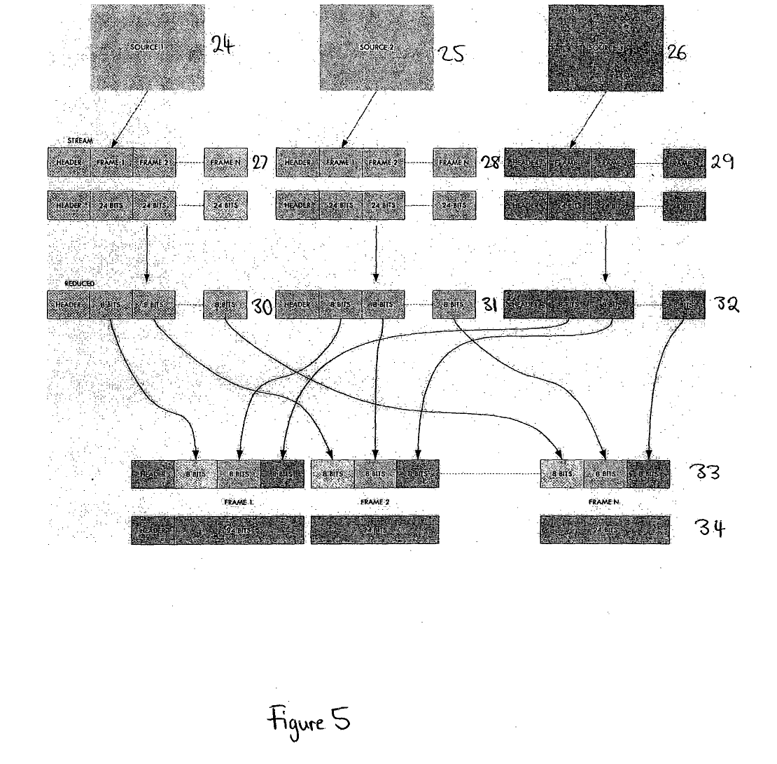

FIG. 3 shows an overview of an example of processing the single merged stream. The figure shows the encoder which reformats the XHD format into HD format, the resulting HD stream, and a decoder. The decoder converts the images back to the XHD format, by applying the reverse reordering process under the control of the key. In this case, the key is sent with the HD stream. This decoder is also shown in FIG. 4 as decoder 17.

Preferably, the input stream information, which may be stored in the palette combination map, is also sent with the single merged stream to the decoder shown in FIG. 4.

At the XHD stream splitter 18, the merged single stream, in this case XHD, is received. The palette combination map, including the input stream information such as number of input streams, position of images and image pixels within those streams, is also received. Using this information, the merged single stream is split back into the separated streams, two XHD and one HD, that were merged at 15. These separated streams are at the reduced colour depth.

These separated streams may then be sent to colour depth converters at 19, 20 and 21. The colour depth of the separated streams may be converted back to the colour depth of the original input streams 9, 10 and 11. Therefore, converting the 8-12 bits of each reduced pixel back to 24-32 bits. It is desirable to convert the bit depth back to a standard bit depth supported by current hardware. Standard converters to perform this function are well known in the art, using techniques, such as palettes, as used by the GIF standard.

It will be appreciated that the output streams from the colour depth convertors 19, 20 and 21 have an altered quality of colour, as compared to the input streams, due to the use of quantisation and compression used during processing. However, the inventor has appreciated that slight alteration is not obvious to the human eye and for many applications, particularly those operating in real time, such reduced quality is acceptable and outweighed by the advantages obtained.

The output streams may now be rendered at 22 and displayed at 23. The display could be, for example, a 360 video player where the end user could pan tilt and zoom into a 3D world.

The embodiment described has the advantage that multiple video streams, which may be of different formats, can be processed, that is compressed, transported and/or stored, as a single stream having a known format. This simplifies hardware arrangements required for processing. Combining the streams in this way also means that the length of the single merged stream need not be longer than the length of the longest input stream. This is useful for storage and transportation of the streams. Also, since the bandwidth is reduced prior to transmission, the method is suitable for real time applications. The embodiment also has the advantage that the streams remain synchronised during delivery (ie the way in which the streams are combined does not change during transmission). In this embodiment, the streams are combined so that corresponding frames in time taken are combined. In the applications described this is particularly advantageous, since it enables the full environment to be viewed simultaneously in real time.

It will be appreciated by the skilled person that the examples of use of the invention are for illustration only and that the invention could be utilised in many other ways. The invention is particularly useful where a process needs the synchronisation between multiple video sources to remain fixed during transmission and processing. Image frames may be synchronised so that frames captured at the same point in time or at a known time difference may arrive at a destination together, for example. Synchronisation may be advantageous if a correlation operation is desired, for example in movement analyse, stereoscopic 3D or stitching. However, the invention is not limited to such applications and may be used in many applications where it is desired to process multiple streams as a single stream.

It will also be appreciated that the number of streams to be merged, and the image formats of the streams, may vary. Many combinations and ways of reducing the colour depth and merging the streams to produce a stream of known format are possible and will occur to the person skilled in the art.

Various other modifications to the embodiments described are possible and will occur to those skilled in the art without departing from the scope of the invention which is defined by the following claims.

1. A method for processing image data representing pixels arranged in frames, comprising:
processing two or more streams of image data to reduce the bit depth of data representing the pixels to produced reduced bit depth streams;
combining the reduced bit depth streams into a single stream having a bit depth at least equal to the sum of the bit depths of the reduced bit depth streams;
delivering the single stream in a known format; and
converting the single stream back into two or more streams of image data.

2. A method according to claim 1, wherein combining the reduced bit streams into a single stream comprises combining the bits making up data frames from the reduced bit streams to form single data frames in the single stream by concatenation of bits.

3. A method according to claim 1, wherein the streams are combined according to a control.

4. A method according to claim 3, wherein the control includes instructions as to where the bits from the reduced bit streams go in the single stream.

5. A method according to claim 3, wherein the control is a palette combination map.

6. A method according to claim 3, wherein the control includes an encryption key.

7. A method according to claim 3, wherein the control is a look up table.

8. A method according to claim 3, wherein the control includes information on the number of image frames to be processed, number of streams of image data to be combined, and position of image pixels within them.

9. A method according to claim 1, further comprising converting the reduced bit depth steams back, at least partially, to their original bit depth.

10. A method according to claim 5, wherein the single stream is processed as data files which include the palette combination map.

11. A method according to claim 1, wherein the sum of the bit depths is a standard bit depth supported by the required hardware.

12. A method according to claim 1, wherein the sum of the bit depths is 24 or 32 bits.

13. A method according to claim 1, wherein image frames of the reduced bit depth streams that correspond to each other are combined.

14. A method according to claim 13, wherein the image frames correspond in that the pixels were captured at the same point in time or at a known time difference.

15. A method according to claim 1, wherein the streams to be processed are acquired from more than one image source.

16. A method according to claim 1, wherein the streams of image data are acquired in the same format.

17. A method according to claim 1, wherein the streams of image data are acquired at different formats.

18. A method according to claim 1, further comprising using padding bits to form the single stream having a bit depth equal to or grater than the sum of the bit depths of the reduced bit depth streams.

19. A method according to claim 1, wherein the single stream has an image format equal to the largest image format of the input stream.

20. A method according to claim 1, wherein the single stream at a first format may be processed according to a second format.

21. A method according to claim 1, wherein the images are video images.

22. A method according to claim 1, wherein the image data is processed in real time.

23. A system for processing image data representing pixels arranged in frames, comprising:
a processor for processing two or more streams of image data to reduce the bit depth representing the pixels to produce reduced bit depth streams;
a combiner for combining the reduced bit depth streams into a single stream having a bit depth at least equal to the sum of the bit depths of the reduced bit depth streams;
a deliverer for delivering the single stream in a known format; and
a converter for converting the single stream back into two or more streams of image data.

24. A system according to claim 23, wherein the combiner for combining the reduced bit streams into a singled stream comprises a bit combiner for combining the bits making up data frames from the reduced bit streams to form single data frames in the singles stream by concatenation of bits.

25. A system according to claim 23, having a control for providing control as to where the bits from the reduced bit streams go in the single stream.

26. A system according to claim 25, wherein the control is a palette combination map.

27. A system according to claim 25, wherein the control includes an encryption key.

28. A system according to claim 25, wherein the control is a look up table.

29. A system according to claim 25, wherein the control includes information on the number of image frames to be processed, number of streams of image data to be combined and position of image pixels within them.

30. A system according to claim 23, wherein the sum of the bit depths is a standard bit depth supported by the required hardware.

31. A system according to claim 23, wherein the sum of the bit depths is 24 or 32 bits.

32. A system according to claim 23, wherein image frames of the reduced bit depth streams that correspond to each other are combined.

33. A system according to claim 32, wherein the image frames correspond in that the pixels were captured at the same point in time or at a known time difference.

34. A system according to claim 23, further comprising an applier for applying padding bits to form the single stream having a bit depth equal to or greater than the sum of the bit depths of the reduced bit depth streams.

35. An encoder for processing image data representing pixels arranged in frames for transmission, comprising:
a processor for processing two or more streams of image data to reduce the bit depth of data representing the pixels to produce reduced bit depth streams;
a combiner for combining the reduced bit depth streams into a single stream having a bit depth at least equal to the sum of the bit depths of the reduced bit depth streams;
a deliver for delivering the single stream in a known format for transmission.

36. A decoder for use with the encoder of claim 35, comprising a converter for converting the single stream back into two or more streams of image data.
